(19) United States
(12) Patent Application Publication
(10) Pub. No.: US 2014/0230238 A1
(43) Pub. Date: Aug. 21, 2014

(54) MANUFACTURING METHOD OF REACTOR (AS AMENDED)

(71) Applicants: Yasuhiro Ueno, Toyota-shi (JP); Fumio Nomizo, Toyota-shi (JP)

(72) Inventors: Yasuhiro Ueno, Toyota-shi (JP); Fumio Nomizo, Toyota-shi (JP)

(21) Appl. No.: 14/237,650

(22) PCT Filed: Nov. 4, 2011
(86) PCT No.: PCT/JP2011/075472

§ 371 Date: Feb. 7, 2014

(51) Int. Cl. H01F 41/10

(52) U.S. Cl. CPC H01F 41/10
USPC 29/602.1

(57) ABSTRACT

A manufacturing method of a reactor which reduces a possibility of leakage of resin into the vicinity of a lead is provided. The method comprising: preparing a bobbin divided into two parts along a longitudinal direction of the bobbin; inserting each of the parts of the bobbin from each side of the coil; and forming a resin so as to cover the coil between flanges of the bobbin; wherein a slit is provided at least one of the flanges and a lead of the coil is passed through the slit while inserting the parts of the bobbin.

### TECHNICAL FIELD

The present application relates to a reactor (a passive element utilizing a coil) and its manufacturing method. The reactor is also referred to as an “inductor”.

### DESCRIPTION OF RELATED ART

In recent years, hybrid and electric vehicles have been fully put into practical use and have been gaining popularity. These vehicles use a motor as a power source and have a reactor in their electric circuit for the motor in many cases. The reactor is used in an inverter or voltage converter for smoothing an electric current. The main body of the reactor is configured of a core and a winding wire (a coil) wound onto the core. Ferrite is often used as the core.

The reactor may or may not contain a bobbin onto which the coil (the winding wire) is wound. Many reactors for smoothing a large current are generally provided with the bobbin. The core is passed through the bobbin having flanges at both sides and the coil (the winding wire) is wound between the flanges of the bobbin. Such reactors are disclosed in Patent documents 1 to 3 for example. In all these reactors, the whole of the coil is covered by an insulating material for insulation. The cover of the coil is advantageously formed by resin casting from a cost viewpoint.

### PRIOR ART DOCUMENTS

### Patent Literature

Patent document 1: Japanese Patent Application Publication No. 2010-245457

Patent document 2: Japanese Patent Application Publication No. 2011-100842

Patent document 3: Japanese Patent Application Publication No. 2010-245154

### BRIEF SUMMARY OF INVENTION

When a coil is covered by resin, a lead of the coil needs to be drawn out from the resin. A casting equipment in which the resin is filled so as to surround the lead may have a complicated structure. For example, in such equipment, positions of the lead and a die need to be precisely adjusted so that the lead is enclosed in the closed die. If a cavity through which the lead is passed is extended, the resin may leak from around the lead upon casting the resin. It is provided herein a reactor which reduces a possibility of leakage of resin into the vicinity of the lead. It is also provided herein a technique which allows production of the reactor at low cost while reducing the possibility of leakage of resin into the vicinity of the lead.

The technique disclosed herein surrounds a part (or all) of a lead of a coil (a winding wire) with resin before casting the resin, for which a flange of a bobbin is utilized. The bobbin is often made of resin, and therefore is an insulating material. An end of the coil comes into contact with the flange of the bobbin. According to a novel reactor disclosed herein, a slit is provided on a flange of the bobbin, and a lead of the coil extends through the slit. The coil is covered by resin from one flange to the other flange of the bobbin. More specifically, the resin contacts both flanges as well as covers the coil from one flange to the other. When casting the resin, resin needs to be filled only at an opening of the slit. When the resin is filled into a die, the flange holding the lead in its slit can prevent the leakage of the resin. Accordingly, the reactor is provided in which the whole of the coil is covered by the resin while reducing the possibility of leakage of the resin into the vicinity of the lead.

Providing the slit at the flange for holding the lead can eliminate the need for providing a space for enclosing the lead in the die for casting the resin.

The above reactor allows the resin being produced with a simple die. The above reactor does not require a complicated die or production equipment and therefore can be manufactured at low cost.

It is not necessary that the whole coil is completely covered by the resin. A window may be provided on the resin and a portion of the coil may be exposed through the window,

The above reactor can be suitably manufactured by the following steps. First, a bobbin containing a core is prepared which is divided into two parts along a longitudinal direction of the bobbin. Next, each of the parts of the bobbin is inserted from each side of the coil. Then, resin is formed so as to cover the coil between flanges of the bobbin. As described above, at least one flange of the bobbin is provided with a slit. A lead of the coil is drawn out from the slit while inserting the parts of the bobbin into the coil. Upon casting the resin, an opening of the slit is covered by a cover.

Further improvements according to the present invention are illustrated by embodiments of the present invention.

### BRIEF DESCRIPTION OF DRAWINGS

FIG. 1 is an exploded perspective view of a reactor (without resin

FIG. 2 is a perspective view of a bobbin;

FIG. 3 is a perspective view of the reactor (without resin);

FIG. 4 is an enlarged plan view around a slit of a flange;

FIG. 5 is a perspective view of the reactor (with resin);

FIG. 6 is a perspective view of a reactor (without resin) of a second embodiment; and

FIG. 7 is a perspective view of a reactor of a third embodiment.

### DETAILED DESCRIPTION OF INVENTION

### First Embodiment

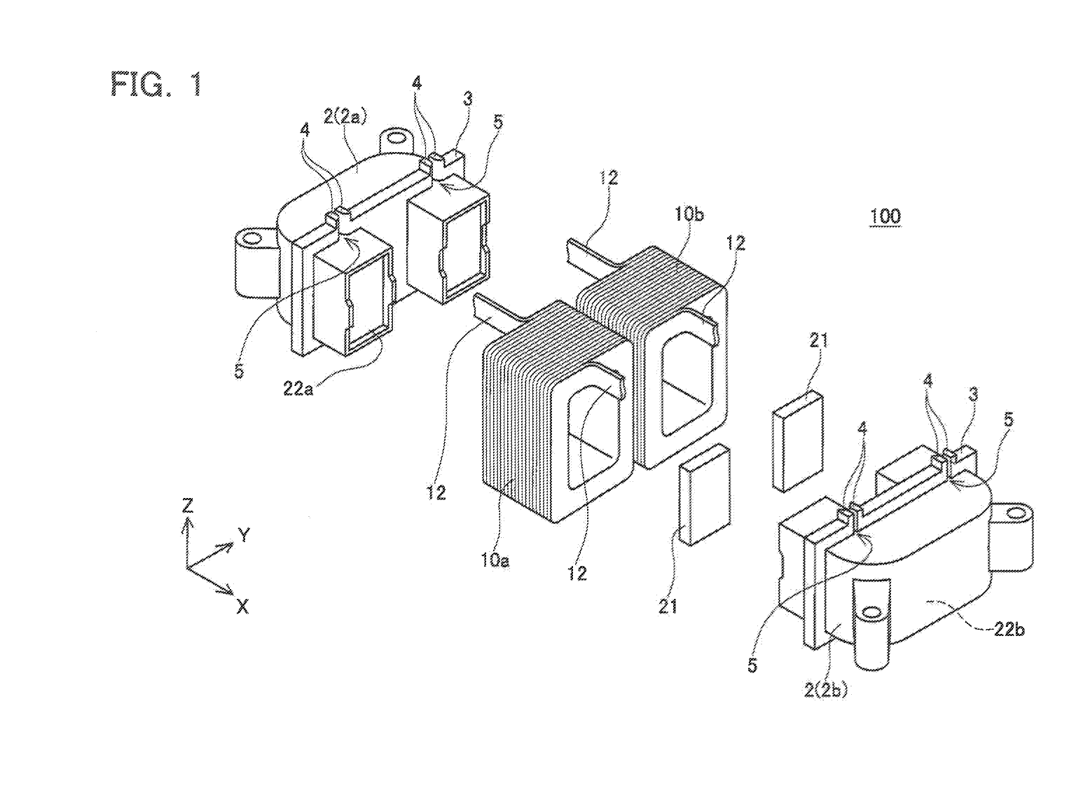

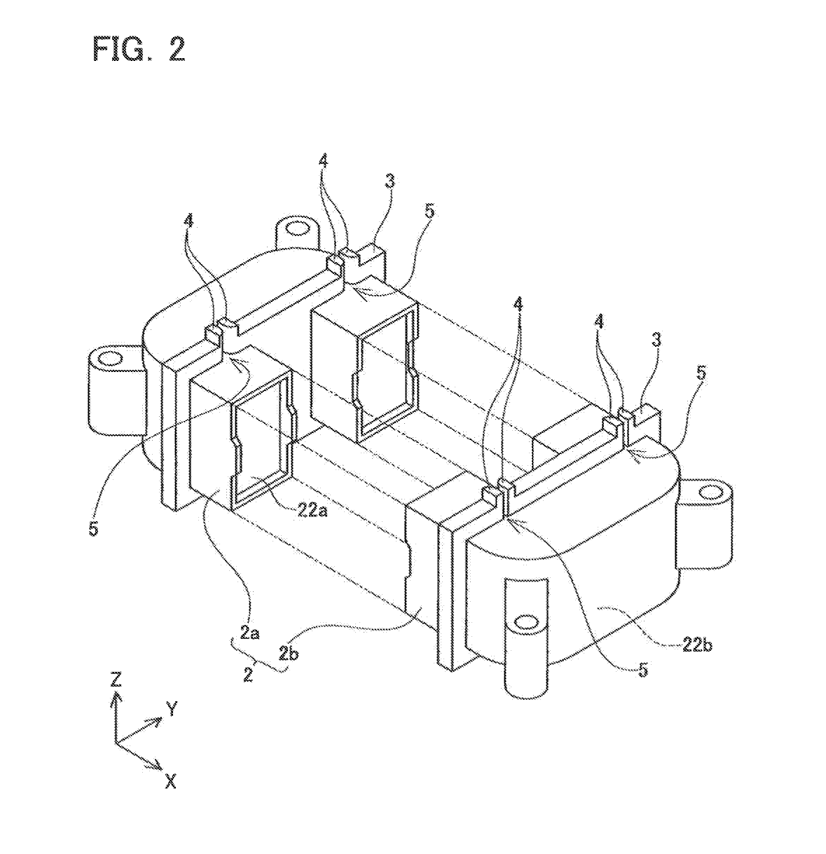

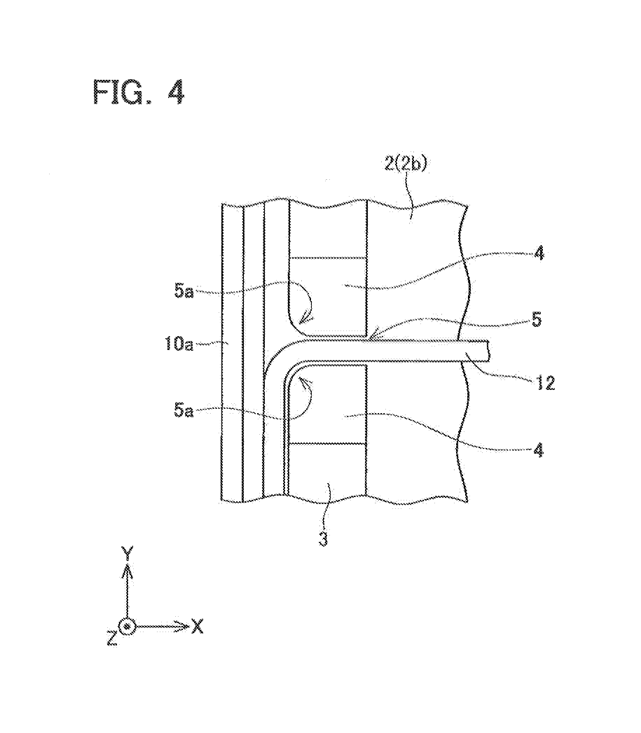

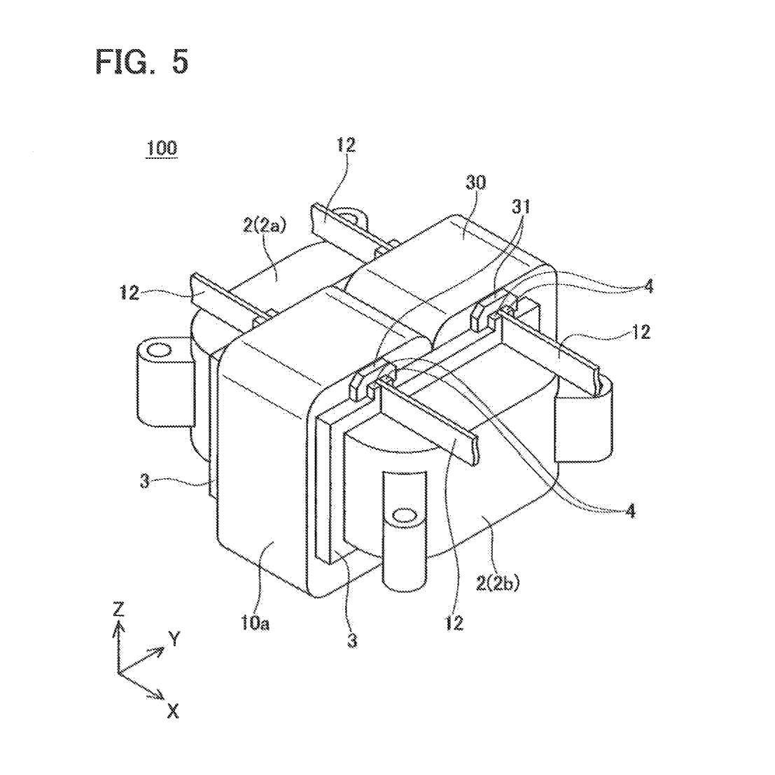

A reactor of the first embodiment is illustrated with referring to the figures. FIG. 1 shows an exploded perspective view of a reactor 100, FIG. 2 shows a perspective view of a bobbin and FIG, 3 shows a perspective view of the reactor (semifinished, without resin). The resin is omitted in FIG. 1. FIG. 4 shows an enlarged plan view around a slit provided on a flange. FIG. 5 shows a perspective view of the completed reactor. The reactor 100 may for example be used for smoothing an electric current in an electric vehicle. The reactor 100 is for a large electric current and a rectangular wire is used as a winding wire. The rectangular wire is a conductive wire having a rectangular cross section.

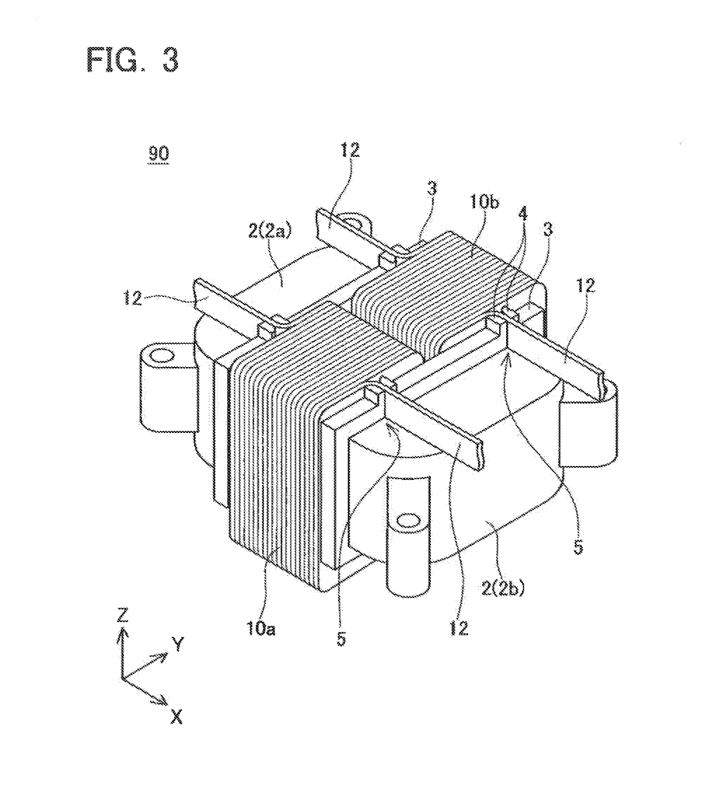

The reactor 100 is now outlined. In the reactor 100, a ring-shaped core is covered by as bobbin 2 made of resin. Winding wires are wound at two positions of the bobbin 2 to form two coils 10a and 10b (see FIG. 3). The coils 10a and 10b are formed between flanges 3 at both sides of the bobbin (FIG. 3). The coils 10a and 10b are covered by resin 30 (a resin cover portion) between the flanges 3 (FIG. 5). Each lead 12 of each coil is drawn out between the flange 3 and resin 30.

The reactor 100 is illustrated in detail hereinbelow. As shown in FIG. 2, the ring-bobbin 2 is divided into two parts 2a and 2b roughly at a center in a longitudinal direction (an x-axis direction). Accordingly, each part 2a or 2b has a c-shape.

Cores 22a and 22b having a c-shape are embedded in the bobbin parts 2a and 2b, respectively. The cores 22a and 22b are made of ferrite. When the bobbin parts 2a and 2b face each other, the cores 22a and 22b also face each other, thereby forming the core having the ring shape.

On both sides of the bobbin 2, the flanges 3 are provided. The wires are wound between the flanges 3 on both sides to form the coils 10a and 10b. The flanges 3 define a position of each coil. in other words, the flanges 3 are positioned at both sides of each coil. The flange 3 is provided with slits 5. As shown in FIG. 3, the leads 12 of the coils 10a and 10b pass through the slits 5. Ribs 4 extend from the flange 3 which flank the slit 5. Ribs 4 secure a height of the slit 5 corresponding to a width of the lead 12 having the rectangular cross section. Namely, a size of the cross section of the slit 5 is approximately the same as a size of the cross section of the lead 12 of the coil.

The reactor 100 is illustrated according to manufacturing procedures. First of all, the bobbin 2 which is divided into two parts along the longitudinal direction is prepared (FIG. 2), The bobbin part 2a is formed by placing the c-shaped core 22a in a die and injecting resin into a cavity around the core 22a. Namely, the bobbin part 2a containing the core is formed by resin injection casting. The other bobbin part 2b is produced in a similar manner.

As shown in FIG. 1, the bobbin parts 2a and 2b are then respectively inserted from the respective sides of the coils 10a and 10b. Upon insertion of the bobbin parts 2a and 2b into the coils 10a and 10b, spacers 21 are placed between two bobbin parts 2a and 2b. The spacers 21 are made of a non-magnetic material. A material for the spacers 21 is, for example, alumina ceramics,

The bobbins 2a and 2b are connected by an adhesive. The leads 12 of the coils pass through the slits 5 provided on the flanges 3 of the bobbins 2a and 2b. As described above, the size of the slit 5 is approximately the same as the cross sectional size of the lead 12, so that the lead 12 fits into the slit 5 substantially without space.

FIG, 4 shows the plan view of the vicinity of the slit 5. As shown in FIG. 4, corners 5a at an inner side (a side facing the coil 10a) of the slit 5 curve from an inner surface of the flange toward side walls of the slit. When the bobbin part 2a (2b) is inserted into the coil 10a, (10b), the lead 12 enters from one side of the slit 5 along a curved corner 5a of the slit to the other side of the slit 5. In other words, the lead 12 curves along the curved corner 5a of the slit.

After insertion of the bobbin parts 2a and 2b from both sides of the coils 10a and 10b, a semifinished reactor 90 is obtained as shown in FIG. 3. The semifinished product 90 is then placed in another die, resin is filled between the flanges 3 on both sides, thereby forming the resin 30 (FIG. 5). As shown in FIG. 5, the resin 30 covers above the rib 4 and lead 12. Namely, the resin 30 blocks the opening of the slit 5. A symbol 31 in FIG. 5 represents a sealing part that covers above the rib 4 and lead 12. The vicinity of each lead 12 is sealed by the slit 5 at the flange 3 and the sealing part 31 of the resin 30. Thereby the reactor 100 is completed.

Features of the reactor 100 are as follows. The reactor 100 is a device in which the bobbin 2 made of resin is formed so as to cover the ring-shaped cores 22a and 22b, and the coils 10a and 10b (winding wires) are wound between the flanges 3 at both sides of the bobbin. The coils 10a and 10bare covered by the flanges 3 of the bobbin 2 and the resin 30. The leads 12 of the coils 10a and 10b are drawn out from the slits 5 provided on the flanges 3. The openings from which the leads 12 are drawn out are surrounded and sealed by the slits 5 and the resin 30. Prior to casting the resin 30, the leads 12 fit into the slits 5. Therefore it is not necessary to fill molten resin to the whole circumference of each lead 12 upon resin casting, and the molten resin seldom leaks from around the leads 12 upon resin casting. According to the above technique, the reactor 100 can be obtained which reduces a possibility of leakage of resin in the vicinity of the leads 12.

Particularly, the corners 5a at the inner side of the slit 5 (a corner facing the coil) curve, and the lead 12 enters into the slit 5 curving along a curved corner (see FIG. 4). Thus, one face of the lead 12 attaches firmly to a wall surface of the slit (the curved corner 5a). This configuration contributes to prevention of the leakage of molten resin. Further, because the corner 5a at the inner side of the slit 5 advantageously curves, the lead 12 can be easily extended through the slit 5. In addition, a side with a broader space between the curved corner 5a and the lead 12 is filled with molten resin.

A step of manufacturing the bobbin part 2a containing the core 22a therein and the bobbin part 2b containing the core 22b therein may be referred to as a primary casting, and a step of injection casting the resin 30 may be referred to as a secondary casting. The bobbin 2 and the resin 30 are made of the same material. Accordingly, the flanges 3 (ribs 4) can fuse with the resin 30 (sealing parts 31).

In the reactor 100, the rectangular wire is used. Most portions of the rectangular wire having a large width are surrounded by the slits 5 of the flanges 3, so that the resin 30 needs to cover only a small part (the upper side of the rectangular wire). Accordingly the die for forming the resin 30 does not need to comprise a space where the rectangular wire is sandwiched. Therefore the resin 30 of the reactor can be formed with the die having a simple shape.

### Second Embodiment

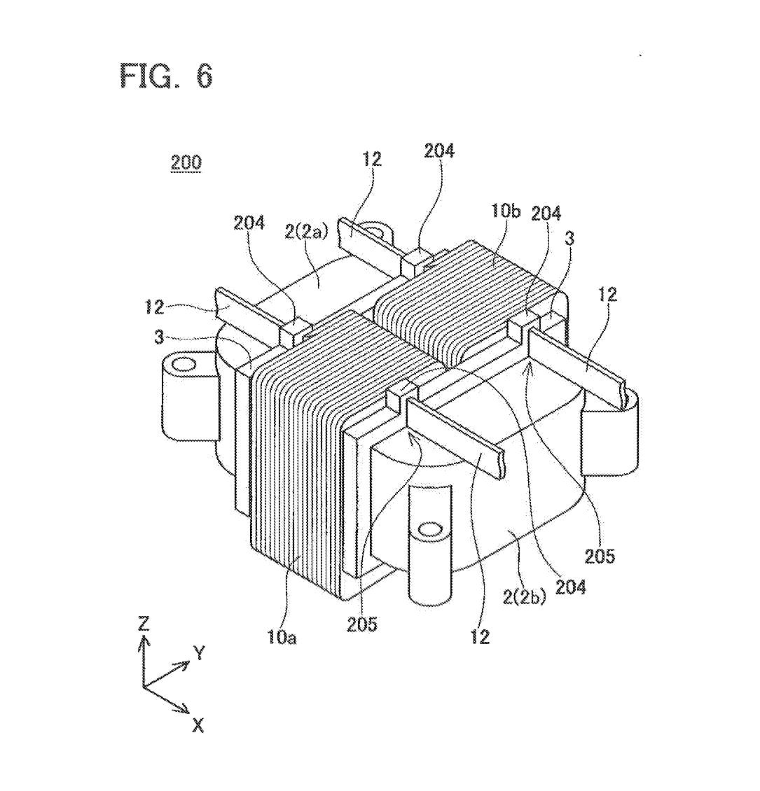

FIG. 6 shows a reactor 200 of the second embodiment. The resin is omitted in FIG. 6. In the reactor 200, each flange 3 is provided with ribs 204, and each rib 204 (flange 3) is provided with a closed slit 205 which surrounds the whole circumference of a lead 12, hi the reactor 200 as well, the size of the slit 205 is approximately the same as the cross sectional size of the lead 12. Other configurations are the same as those of the reactor 100 of the first embodiment. In the reactor 200 of the second embodiment, the whole circumference of the lead 12 is surrounded by the closed slit 205, and leakage of molten resin through a side of the lead 12 upon casting the resin is further effectively prevented.

### Third Embodiment

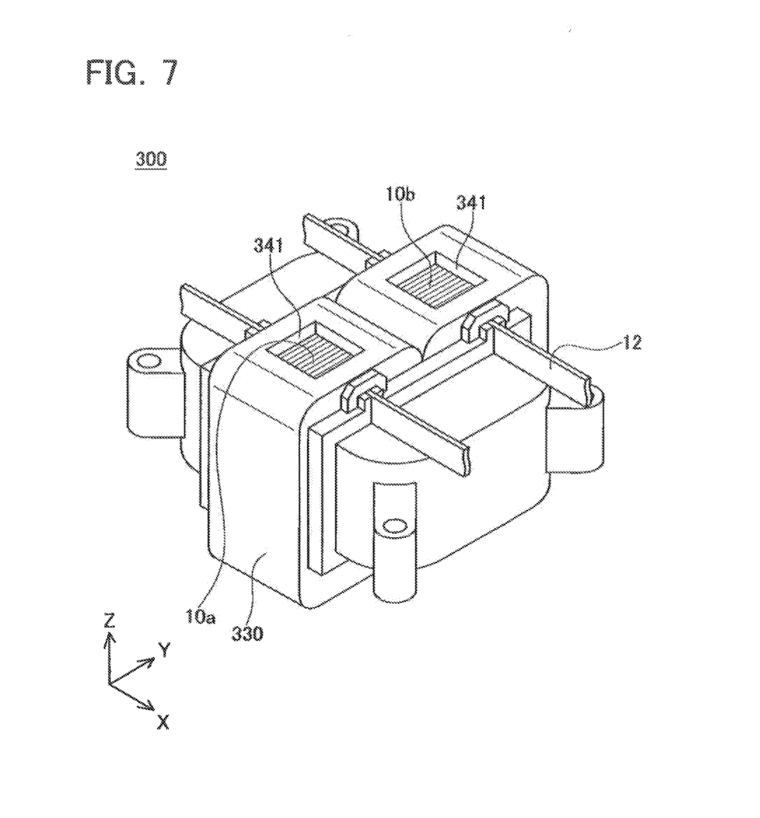

FIG. 7 shows a reactor 300 of the third embodiment. In the reactor 300, windows 341 are provided on resin 330, and a portion of the coil 10a and a portion of the coil 10b are exposed through the windows 341. A heat-transfer material is subsequently applied to each exposed portion in order to release heat of the coil 10a (10b) through the heat-transfer material. Because the heat-transfer material is also an insulating material, the whole coil is covered by the insulating material when completed.

Representative and non-limiting specific examples of the present invention have been illustrated in detail with referring to the drawings. The detailed description intends to illustrate the details for practicing the preferred embodiments of the present invention to a person skilled in the art and does not intend to limit the scope of the present invention. The disclosed additional features and inventions can be used with or without other features and inventions in order to provide a further improved reactor or a manufacturing method thereof.

The combinations of the features and steps disclosed hereinabove are not essential for practicing the present invention in its broadest meaning and are described merely for particularly illustrating representative specific embodiments of the present invention. Further, it is not required that the various features of the representative specific embodiments and the various features described in independent and dependent claims are combined in the same manner as described in the specific embodiments or in the same order as listed herein.

All the features described in the specification and/or claims are intended to be disclosed, apart from the configurations of the features described in embodiments and/or individually and independently from each other as limitations to the original disclosure at the filing and the claimed specific matters. All descriptions on numerical ranges and groups or sets are intended to disclose the configurations in between as the limitations to the original disclosure at the time of filing and the claimed specific matters.

Specific embodiments of the present invention have been illustrated hereinabove in detail. However, they are merely examples and do not limit the scope of the claims. The technique described in the claims comprises various modification and alterations of the above specific embodiments. The technical elements illustrated in the specification and drawings exert technical values alone or in various combinations and are not limited to the combination described in the claims at the time of filing. The techniques exemplified in the specification or drawings can achieve multiple purposes simultaneously and are technically valuable by merely achieving one of the purposes.

1.-4. (canceled)

5. A method of manufacturing a reactor, the method comprising:
preparing a bobbin divided into two parts along a longitudinal direction of the bobbin;
inserting each of the parts of the bobbin from each side of a coil; and
forming resin so as to cover the coil between flanges of the bobbin;
wherein:
a slit is provided on at least one of the flanges; and
a lead of the coil is passed through the slit while inserting the parts of the bobbin.
